(19) United States
(12) Patent Application Publication
(10) Pub. No.: US 2006/0202955 A1
(43) Pub. Date: Sep. 14, 2006

(54) Wireless mouse for receiving a receiver thereunder

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,641

(22) Filed: Mar. 8, 2005

(51) Int. Cl. G09G 5/08

(52) U.S. Cl. 345/163

(57) ABSTRACT

A wireless mouse has a main body and a receiver. The main body has a sensor device and an energy-saving device-disposed thereunder. The receiver is detachably disposed under the main body by a sliding or a retaining method. When the receiver is disposed under the main body, the receiver covers the sensor device and presses the energy-saving device. The wireless mouse is thus easily carried, also prevents the receiver from being damaged or lost and the sensor device from being damaged due to careless placement, and saves energy of the wireless mouse.

### BACKGROUND OF THE INVENTION

1. Field of The Invention

The present invention relates to a wireless mouse for receiving a receiver thereunder, and particularly relates to a receiver disposed under a main body of a wireless mouse by a sliding or retaining method, while at the same time the receiver covers a sensor device of the main body and presses an energy-saving device of the main body.

2. Description of the Related Art

People increasingly like to use a wireless mouse. The wireless mouse is convenient for a user, because the wireless mouse lacks a signal wire. However, a receiver is necessary for the wireless mouse to receive the movement signal of the wireless mouse.

Because of the two-part design of the wireless mouse, the wireless mouse is inconvenient to transport. Moreover, the receiver is easily damaged or lost, or a sensor of the wireless mouse is easily damaged from careless placement.

### SUMMARY OF THE INVENTION

An objective of the present invention is to provide a wireless mouse that can prevent the receiver from being damaged or lost, or the sensor from being damaged due to careless placement. The. present invention thus provides a wireless mouse with a main body and a receiver. The receiver is disposed under a main body by a sliding or retaining method, while the receiver simultaneously covers a sensor device of the main body for protecting the sensor device and presses an energy-saving device of the main body for saving the energy of the wireless mouse.

A first aspect of the invention is a wireless mouse. The wireless mouse has a main body and a receiver. The main body has a sensor device and an energy-saving device disposed thereunder. The receiver is detachably disposed under the main body. When the receiver is disposed under the main body, the receiver covers the sensor device and presses the energy-saving device.

A second aspect of the invention is a wireless mouse. The wireless mouse has a main body and a receiver. The main body has a sensor device, an energy-saving device and a first sliding portion disposed thereunder. The receiver has a second sliding portion corresponding to the first sliding portion. The receiver is disposed under the main body by sliding between the first sliding portion and the second sliding portion. When the receiver is disposed under the main body, the receiver covers the sensor device and presses the energy-saving device.

A third aspect of the invention is a wireless mouse. The wireless mouse has a main body and a receiver. The main body has a sensor device, an energy-saving device and a first retaining portion disposed thereunder. The receiver has a second retaining portion corresponding to the first retaining portion. The receiver is disposed under the main body by retaining retention between the first retaining portion and the second retaining portion. When the receiver is disposed under the main body, the receiver covers the sensor device and presses the energy-saving device.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective, exploded view of a main body and a receiver of a wireless mouse according to the first embodiment of the present invention;

FIG. 2 is a perspective, exploded view of a main body and a receiver of a wireless mouse according to the second embodiment of the present invention;

FIG. 3 is a perspective, assembled view of a main body and a receiver of a wireless mouse according to the first and second embodiments of the present invention; and

FIG. 4 is a perspective, assembled view of a main body and a receiver of a wireless mouse according to the third embodiment of the present invention.

### DETAILED DESCRIPTION OF PREFERRED EMBODIMENTS

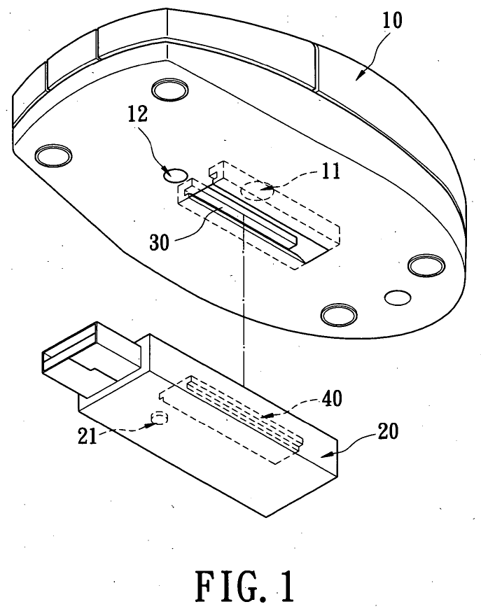

FIG. 1 shows a perspective, exploded view of a main body and a receiver of a wireless mouse according to the first embodiment of the present invention. The present invention provides a wireless mouse, and includes a main body 10 and a receiver 20.

The main body 10 has a sensor device 11 and an energy-saving device 12 disposed thereunder. Wherein the sensor device 11 is a sensor. The receiver 20 is detachably disposed under the main body 10, and has a pressing body 21 for pressing the energy-saving device 12.

Moreover, the main body 10 has a first sliding portion 30 disposed thereunder. The receiver has a second sliding portion 40 corresponding to the first sliding portion 30. Hence the receiver 20 is disposed under the main body 10 by a sliding method between the first sliding portion 30 and the second sliding portion 40.

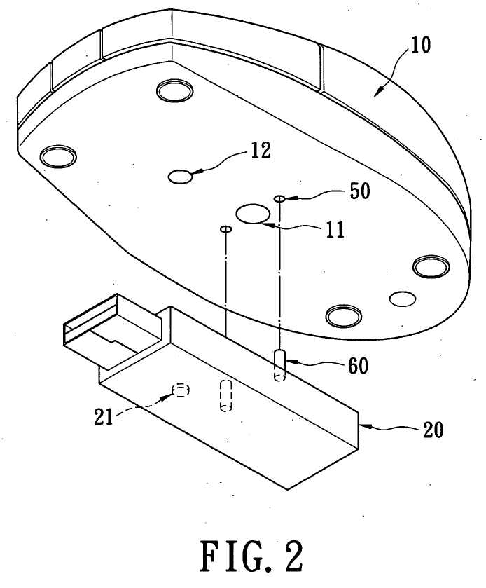

FIG. 2 shows a perspective, exploded view of a main body , and a receiver of a wireless mouse according to the second embodiment of the present invention. The main body 10 has a first retaining portion 50 disposed thereunder. The receiver 20 has a second retaining portion 60 corresponding to the first retaining portion 50. The receiver 20 is disposed under the main body 10 by a retaining method between the first retaining portion 50 and the second retaining portion 60.

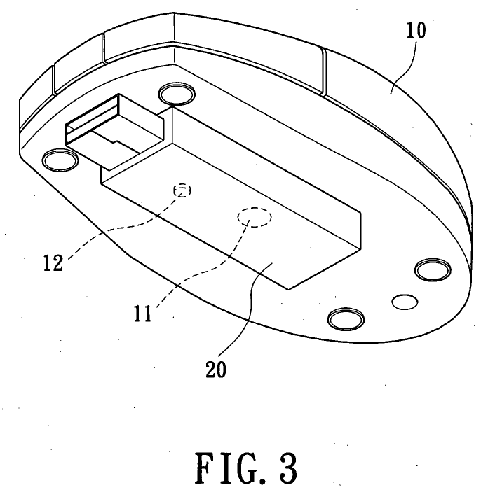

FIG. 3 shows a perspective, assembled view of a main body and a receiver of a wireless mouse according to the first and second embodiments of the present invention. When the receiver 20 is disposed under the main body 10, the receiver 20 covers the sensor device 11 of the main body 10 for protecting the sensor device 11 and presses the energy-saving device 12 of the main body for saving the energy of the wireless mouse. Hence the wireless mouse of the present invention is not only easily carried, but also prevents the receiver 20 from being damaged or lost and the sensor device 11 from being damaged due to careless placement, and saves energy for the wireless mouse.

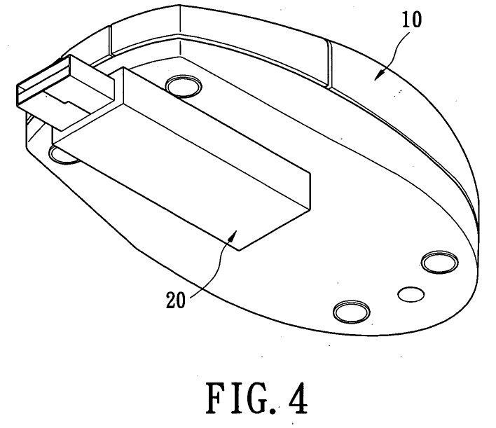

FIG. 4 shows a perspective, assembled view of a main body and a receiver of a wireless mouse according to the third embodiment of the present invention. When the receiver 20 is disposed under the main body 10 of the wireless mouse, the receiver 20 has a front side projected out of the main body 10. Hence it is easy for user to insert the receiver 20 into a slot (not shown) along a direction, and move the main body 10 of the wireless mouse along a reversed direction to finish the insertion action of the receiver 20.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless mouse, comprising:
a main body having a sensor device and an energy-saving device disposed thereunder; and
a receiver detachably disposed under the main body;
whereby, when the receiver is disposed under the main body, the receiver covers the sensor device and presses the energy-saving device.

2. The wireless mouse as claimed in claim 1, wherein the receiver is disposed under the main body by a sliding method.

3. The wireless mouse as claimed in claim 1, wherein the receiver is disposed under the main body by a retaining method.

4. The wireless mouse as claimed in claim 1, wherein the receiver has a pressing body for pressing the energy-saving device.

5. A wireless mouse, comprising:
a main body having a sensor device, an energy-saving device and a first sliding portion disposed thereunder; and
a receiver having a second sliding portion corresponding to the first sliding portion, wherein the receiver is disposed under the main body by sliding between the first sliding portion and the second sliding portion;
whereby, when the receiver is disposed under the main body, the receiver covers the sensor device and presses the energy-saving device.

6. A wireless mouse, comprising:
a main body having a sensor device, an energy-saving device and a first retaining portion disposed thereunder; and
a receiver having a second retaining portion corresponding to the first retaining portion, wherein the receiver is disposed under the main body by retention between the first retaining portion and the second retaining portion;
whereby, when the receiver is disposed under the main body, the receiver covers the sensor device and presses the energy-saving device.
